(19) United States
(12) Patent Application Publication
(10) Pub. No.: US 2017/0337532 A1
(43) Pub. Date: Nov. 23, 2017

(54) PAYMENT PROCESSING METHOD, AND PAYMENT PROCESSING SERVER AND COMPUTER PROGRAM PERFORMING THE PAYMENT PROCESSING METHOD

(71) Applicant: LINE Corporation, Tokyo (JP)

(72) Inventor: Won Joon CHOI, Seongnam-si (KR)

(73) Assignee: LINE Corporation, Tokyo (JP)

(21) Appl. No.: 15/478,606

(22) Filed: Apr. 4, 2017

(30) Foreign Application Priority Data
May 17, 2016 (KR) 10-2016-0060138

(51) Int. Cl. G06Q 20/10; H04L 12/58

(52) U.S. Cl. CPC G06Q 20/102; H04L 51/046

(57) ABSTRACT

Provided are payment processing methods, payment processing servers, and/or computer programs for performing the payment processing methods, in which payment is made, without having to be directly connected to a buyer, according to the payment request received from a seller terminal of a seller. The payment request may be generated by combining a payment identification (ID) issued to a buyer terminal and sale information generated by the seller terminal. Further, communication may be initiated or performed based on transaction data without having to exchange personal ID information between the buyer and the seller.

### CROSS-REFERENCE TO RELATED APPLICATION

This application claims priority under 35 U.S.C. §119 to Korean Patent Application No. 10-2016-0060138, filed on May 17, 2016, in the Korean Intellectual Property Office, the entire contents of which are incorporated herein by reference.

### BACKGROUND

### 1. Field

One or more example embodiments relate to payment processing methods, payment processing servers, and/or computer programs performing the payment processing methods.

### 2. Description of the Related Art

This section provides some background information, which is not necessarily prior art, related to the present disclosure.

A payment gateway service is a service of relaying and/or settling an electronic payment such that a price is paid and settled via a credit card or another payment method when a payer pays for a product or a service of a seller through online electronic commerce. The payment gateway service provides various payment methods in electronic commerce (e.g., payment by credit card, account transfer, and/or mobile phone micropayment).

The payment gateway service is a payment method that is safe and easy to manage because the seller uses a payment system and a security solution provided by the payment gateway service without having to build a separate system of his or her own. Accordingly, recently, use of the payment gateway service is increasing not only in large scale online shopping websites, but also in medium and small scale online shopping websites and personal social media. Further, the use of the payment gateway service has been enlarged to offline face-to-face payments by using a point of sale (POS) terminal.

Also, terminals of the seller and the payer conducting the electronic commerce are being diversified, from a general computer (e.g., a desktop computer or a laptop computer) to the latest smart device (e.g., a smart phone, a tablet personal computer (PC), or a smart television (TV)).

For example, Korean Patent Application Publication No. 2014-0076711 (Title of Invention: “Method for Executing Payment in Payment Server”) discloses a method of rewarding a buyer with a profit with respect to a product purchased by connecting a payment method and a discount policy by using a portable terminal.

### SUMMARY

This section provides a general summary of the inventive concepts, and thus may not be a comprehensive disclosure of the full scope or all features of the inventive concepts.

One or more example embodiments include payment processing servers, payment processing methods, and/or computer programs performing the payment processing methods, whereby payment is made, without having to be directly connected to a buyer, according to the payment request received from a seller terminal. The payment request may be generated by combining a payment identification (ID) issued to a buyer terminal and sale information generated by the seller terminal.

Further, one or more example embodiments include payment processing servers, payment processing methods, and computer programs performing the payment processing methods, in which communication is initiated or performed based on transaction data without an exchange of personal ID information between a buyer and a seller.

Additional aspects will be set forth in part in the description which follows and, in part, will be apparent from the description, or may be learned by practice of the presented example embodiments.

According to an example embodiment, a payment processing method performed by a payment processing server, the payment processing server including a communication interface and a processor, includes receiving, by the communication interface, a payment request comprising a payment identification (ID) from a first user terminal of a first user, primarily determining, by the processor, whether the payment ID satisfies a certain regulation, and whether a validity period of the payment ID has elapsed, searching for a second user who received the payment ID, and secondarily determining whether a payment method related to the second user exists and whether a validity period of the payment method has elapsed in response to results of the primary determination that the payment ID satisfies the certain regulation and the validity period of the payment ID has not elapsed, evaluating that the payment request is valid in response to results of the secondary determination that the payment method exists and the validity period of the payment method has not elapsed, generating a packet including a transaction ID corresponding to the payment request, and storing the packet in a message queue in response of the payment request being valid, and processing the payment request to make a payment corresponding to the payment request.

In some example embodiments, the transaction ID may include a portion corresponding to a buyer code, a portion corresponding to a seller code, and a portion corresponding to payment information.

In some example embodiments, the payment processing method may further include transmitting sales data generated based on a store, a sales item, and a selling price, which are included in results of the processing the processed payment request, to a second user terminal of the second user, receiving a transmission message with respect to the sales data from the second user terminal, determining a recipient of the transmission message by using a transaction ID derived by analyzing the transmission message, and transmitting the transmission message to a user terminal of the recipient.

In some example embodiments, the transmission message may include at least one of a menu completion notification, a product delivery notification, an out-of-stock notification, and a delivery schedule notification.

In some example embodiments, the payment processing method may further include transmitting purchase data generated based on a store, a sales item, and a selling price, which are derived by analyzing results of the processing the payment request, to the first user terminal, receiving an inquiry message with respect to the purchase data from the first user terminal, extracting a seller of the purchase data by using a transaction ID extracted from the received inquiry message, modifying the inquiry message to be linked to sales data corresponding to the purchase data, and transmitting the inquiry message to a user terminal of the seller.

In some example embodiments, the payment ID may be generated in response to a payment start request from a second user terminal, and is transmitted only to the second user terminal.

In some example embodiments, the payment processing method may further include receiving a chat room open request using sales data of the second user terminal, extracting a participant of a chat room by using a transaction ID obtained by analyzing the chat room open request, and opening the chat room including the participant.

In some example embodiments, the payment processing method may further include enabling the second user to exchange a message with the participant using the transaction ID without exposing respective personal information to each other.

In some example embodiments, the payment processing method may further include receiving a chat room open request using purchase data of the first user terminal, extracting a participant of a chat room by using a transaction ID obtained by analyzing the chat room open request, and opening the chat room including the participant.

In some example embodiments, the payment processing method may further include enabling the first user to exchange a message with the participant using the transaction ID without exposing respective personal information to each other

According to an example embodiment, a payment processing server includes a communication interface and a processor. The communication interface may be configured to receive a payment request, the payment request including a payment identification (ID) from a first user terminal of a first user. The processor may be configured to primarily determine whether the payment ID satisfies a certain regulation, and whether a validity period of the payment ID has elapsed, when it is determined that the payment ID satisfies the certain regulation and the validity period of the payment ID has not elapsed based on the primarily determination, search for a second user who received the payment ID, and secondarily determine whether a payment method related to the second user exists and whether a validity period of the payment method has elapsed, when it is determined that the payment method exists and the validity period of the payment method has not elapsed based on the secondarily determination, evaluate that the payment request is valid, and when it is evaluated that the payment request is valid, generate a packet including a transaction ID corresponding to the payment request, store the packet in a message queue, and processing the payment request to make a payment corresponding to the payment request.

In some example embodiments, the processor may be further configured to transmit sales data generated based on a store, a sales item, and a selling price, which are included in results of the processing the payment request to a second user terminal of the second user, receive a transmission message with respect to the sales data from the second user terminal, determine a recipient of the transmission message by using a transaction ID derived by analyzing the transmission message, and transmit the transmission message to a user terminal of the recipient.

In some example embodiments, the transmission message may include at least one of a menu completion notification, a product delivery notification, an out-of-stock notification, and a delivery schedule notification.

In some example embodiments, the processor may be further configured to transmit purchase data generated based on a store, a sales item, and a selling price, which are derived by analyzing results of the processing the payment request to the first user terminal, receive an inquiry message with respect to the purchase data from the first user terminal, extract a seller of the purchase data by using a transaction ID extracted from the received inquiry message, modify the inquiry message to be linked to sales data corresponding to the purchase data, and transmit the inquiry message to a user terminal of the seller

In some example embodiments, the processor may be further configured to receive a chat room open request using sales data of the second user terminal, extract a participant of a chat room by using a transaction ID obtained by analyzing the chat room open request, and open the chat room including the participant.

In some example embodiments, the processor may be further configured to enable the second user who has opened the chat room to exchange messages with the participant without exposing respective personal information to each other.

In some example embodiments, the processor may be further configured to receive a chat room open request using purchase data of the first user terminal, extract a participant of a chat room by using a transaction ID obtained by analyzing the chat room open request, and open the chat room including the participant.

In some example embodiments, the processor may be further configured to enable the first user who has opened the chat room to exchange messages with the participant without exposing respective personal information to each other.

According to an example embodiment, a non-transitory computer-readable recording medium storing a computer program, which when executed by a computer, configures the computer to execute the payment processing as stated above may be provided.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram of a payment processing system according to an example embodiment;

FIG. 2 is a block diagram of a structure of a payment processing server according to an example embodiment;

FIG. 3 is a diagram for describing a data exchange between a payment processing server, a user terminal of a buyer, and a user terminal of a seller;

FIGS. 4 through 7 are flowcharts of a payment processing method according to an example embodiment;

FIGS. 8 through 10 are diagrams for describing data exchanges between a payment processing server, a user terminal of a buyer, and a user terminal of a seller; and

FIGS. 11A through 12D are user interfaces provided by a payment processing server.

It should be noted that these figures are intended to illustrate the general characteristics of methods and/or structures utilized in certain example embodiments and to supplement the written description provided below. These drawings are not, however, to scale and may not precisely reflect the precise structural or performance characteristics of any given example embodiment, and should not be interpreted as defining or limiting the range of values or properties encompassed by the example embodiments.

### DETAILED DESCRIPTION

One or more example embodiments will be described in detail with reference to the accompanying drawings. The example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those of ordinary skill in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element, there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, a central processing unit (CPU), a controller, an arithmetic logic unit (ALU), a digital signal processor, a microcomputer, a field programmable gate array (FPGA), a system-on-chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, a CPU, a controller, an ALU, a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording media, including tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such a separate computer readable storage medium may include a universal serial bus (USB) flash drive, a memory stick, a Blu-ray/DVD/CD-ROM drive, a memory card, and/or other similar computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other similar medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one of ordinary skill in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different to that of the methods described, and/or components such as the described system, architecture, devices, circuit, and the like, may be connected or combined to be different from the above-described methods, or results may be appropriately achieved by other components or equivalents.

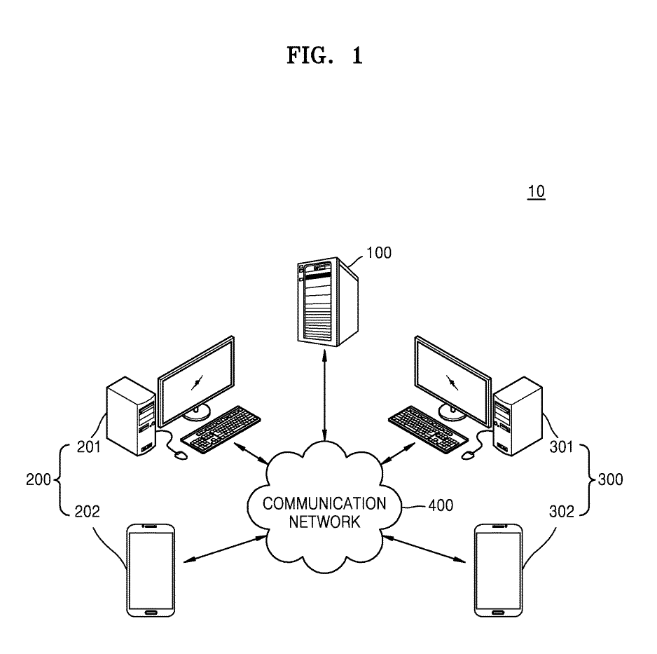

FIG. 1 is a diagram of a payment processing system 10 according to an example embodiment.

Referring to FIG. 1, the payment processing system 10 according to an example embodiment may include a payment processing server 100, user terminals 200 and 300, and a communication network 400.

The payment processing server 100 may distribute a shopping application and/or a payment application to the user terminal 200 of a seller and the user terminal 300 of a buyer. The payment processing server 100 may perform payment by using a payment method of a payer (e.g., the buyer) of a payment request, according to the payment request from the user terminal 200 of the seller. Accordingly, the payment processing server 100 according to an example embodiment may process the payment by using the payment method of the buyer request according to the payment request by the seller, without having to directly use or contact a payment method (e.g., the seller's proprietary payment method) for purchase.

The payment processing server 100 may transmit a transmission message related to a sales activity, which is received from the user terminal 200 of the seller, to the user terminal 300 of the buyer. Here, the transmission message related to the sales activity may include completion of the sales activity, and a delivery state (e.g., in transit or delivery completed). Accordingly, the payment processing server 100 according to an example embodiment may transmit the transmission message related to the sales activity to the user terminal 300 of the buyer by using a payment application in which the sales activity is performed, instead of a one-on-one communication method through a phone number or identification (ID) of the buyer. Thus, the payment processing server 100 according to an example embodiment may receive useful information from the seller without exposing personal information of the buyer.

The payment processing server 100 may transmit an inquiry message received from the user terminal 300 of the buyer to the user terminal 200 of the seller. Accordingly, the payment processing server 100 according to an example embodiment may transmit the inquiry message to the user terminal 200 of the seller by using a payment statement without asking for a phone number or ID of the seller.

The payment processing server 100 may generate or assign a unique transaction ID for individually distinguishing at least one payment statement obtained through the distributed payment application, and manage each payment statement by using the transaction ID. Here, the payment processing server 100 may extract, generate, or search for a buyer code indicating the buyer and a seller code indicating the seller before generating the transaction ID. The payment processing server 100 may generate the unique transaction ID that is accessible and analyzable via the buyer code and the seller code. The transaction ID may not only include the buyer code and/or the seller code, but also include codes that may be substituted by the buyer code and/or the seller code. Further, the transaction ID may include codes substitutable by a payment price, payment product, and/or payment date that are processed according to the payment statement. Thus, the transaction ID may include a plurality of meaningful codes. Here, a code may be a number, an English character, and/or a sign, or a geometric sign substitutable by a number.

The payment processing serer 100 may provide a chat room function through which the buyer and the seller can communicate, by the payment application or the shopping application. The payment processing server 100 may open a chat room between the buyer and the seller without exposing personal information of the buyer and the seller. Thus, the buyer and the seller may interact with each other through the chat room without exposing their personal information.

The seller may access the payment processing server 100 by using the user terminal 200, and may download an application for various sales and/or payment services by accessing the payment processing server 100. The buyer may access the payment processing server 100 by using the user terminal 300, and download an application for various shopping and/or payment services by accessing the payment processing server 100.

The user terminals 200 and 300 denote communication terminals capable of using a web service in a wired/wireless communication environment. Here, the user terminals 200 and 300 may be personal computers (PCs) 201 and 301, or mobile terminals 202 and 302. In FIG. 1, the mobile terminals 202 and 302 are shown as smart phones, but example embodiments are not limited thereto. The mobile terminals 202 and 302 may be any terminal, in which an application capable of web browsing is installed, as described above.

For example, the user terminal 200 or 300 may be a server computer, a desktop computer, a laptop computing device, a consumer electronic device, a mobile computing device, a mobile phone, a smart phone, a tablet computing device, a personal digital assistant, a wearable computing device, a smart television (TV), a smart appliance, or another type of computing device, but is not limited thereto.

The communication network 400 connects the payment processing server 100 to the plurality of user terminals 200 and 300. The communication network 400 denotes a communication network providing an access path for the user terminals 200 and 300 to exchange data with the payment processing server 100 after accessing the payment processing server 100. Examples of the communication network 400 include wired networks (e.g., a local area network (LAN), a wide area network (WAN), a metropolitan area network (MAN), or an integrated service digital network (ISDN)), and wireless networks (e.g., a wireless LAN, CDMA, Bluetooth, or satellite communication), but are not limited thereto.

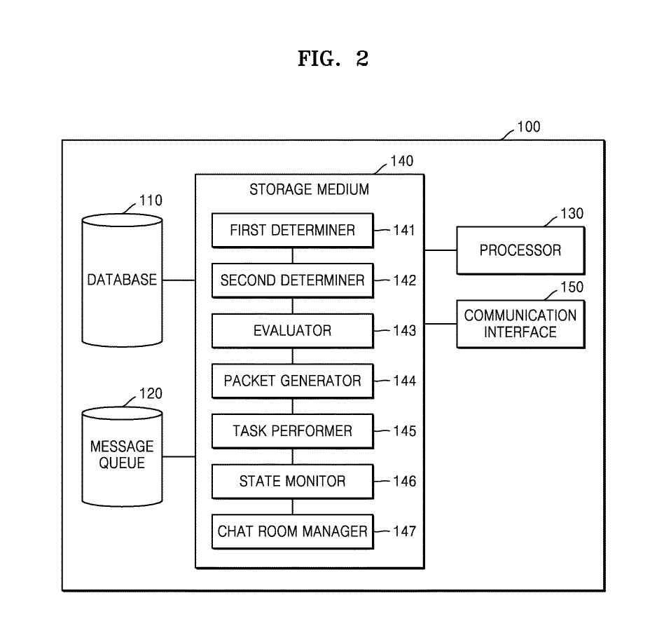

FIG. 2 is a block diagram of a structure of the payment processing server 100 according to an example embodiment.

Referring to FIG. 2, the payment processing server 100 according to an example embodiment may include a database 110, a message queue 120, a processor 130, a storage medium 140, and a communication interface 150.

The database 110 may store and manage information related to at least one buyer and at least one seller registered in the payment processing server 100. The database 110 may store and manage information related to a user ID, a password, and a payment method of the buyer, and information related to a user ID, a password, and an address, phone number; and business registration number of a store of the seller.

The message queue 120 denotes a storage space storing a packet corresponding to payment to be processed. The message queue 120 is controlled by a task performer generated and realized for a payment process. In some exceptional situations, access to the message queue 120 may not be allowed. For example, such exceptional situations may include at least one of when the payment processing server 100 is turned off, when the payment processing server 100 is not connected to a module for a payment process, when an OS of the payment processing server 100 malfunctions, when the payment processing server 100 is attacked by virus or a malignant code, and when a use rate of a CPU or memory is equal to or higher than a desire (or alternatively, pre-set) threshold value (e.g., 90%) by a processor or thread executed by the payment processing server 100.

The processor 130 may include any type of device capable of processing data. Here, the term ‘processor’ may be a data processing device embedded in hardware, and having a physically structured circuit to perform a function expressed in a code or command included in a program. Examples of the data processing device embedded in hardware may include a microprocessor, a CPU, a processor core, a multiprocessor, an application-specific integrated circuit (ASIC), and a FPGA, but are not limited thereto.

The storage medium 140 may store various types of data and software (e.g., an OS, an application, a program, a library, and a driver) used during operations of the payment processing server 100. Here, the storage medium 140 may include a magnetic storage medium or a flash storage medium, but is not limited thereto. The storage medium 140 may store commands for performing a payment processing method according to an example embodiment.

The communication interface 150 may be a device including hardware and software that is capable of exchanging a signal (e.g., a control signal or a data signal) with another network device through wired/wireless connection. The communication interface 150 may receive a request related to payment (e.g., a payment request or a payment start request) from the user terminals 200 and 300, and/or may transmit a payment ID in response to the payment start request to the user terminals 200 and 300. Further, the communication interface 150 may receive a payment request, in which a payment ID obtained through the buyer terminal and sale information generated by the seller are combined, from the seller terminal connected to the buyer terminal via short-range communication. Here, the payment request is received from the seller terminal and the payment start request is received from the buyer terminal Further, the communication interface 150 may selectively transmit a packet stored in the message queue 120 to an external payment gateway server, according to control of the task performer. Further, the communication interface 150 may receive a result of processing the packet from the external payment gateway server. Further, the communication interface 150 may transmit a message received from the user terminal 200 or 300 to the user terminal 300 or 200. The communication interface 150 may receive a chat room open request from the buyer terminal or the seller terminal. The chat room open request may be generated according to certain purchase data or certain sales data.

The storage medium 140 will now be described in detail.

The storage medium 140 may include a first determiner 141, a second determiner 142, an evaluator 143, a packet generator 144, a task performer 145, a state monitor 146, and a chat room manager 147, and execute operations according to one or more example embodiments.

The first determiner 141 may determine whether the payment ID included in the payment request received by the communication interface 150 satisfies a first condition.

For example, the payment request may be a request generated by the payment application installed in the user terminal 200 of the seller and may include registration information pre-registered by the user terminal 200 of the seller, and input information newly input by the user terminal 200 of the seller. For example, the payment request may include the payment ID obtained from the user terminal 300 of the buyer. The payment ID may be a single-use (e.g., one-time) ID or a temporarily valid ID provided to the user terminal 300 of the buyer. The payment ID may identify the user terminal 300 or the buyer while not being relevant to the user terminal 300 of the buyer. Here, the user terminal 300 of the buyer may be generally different from the user terminal 200 of the seller, but may be the same under certain circumstances. For example, a terminal owned by a person who is both a buyer and a seller may be both a buyer terminal and a seller terminal. Here, the first condition is a condition regarding the payment ID. The first condition may include at least one of whether a number, a sign, an English character, or the like included in the payment ID satisfies a regulation of payment ID, whether a validity period of the payment ID is expired, and whether a location of the user terminal 200 of the seller is within a desired (or alternatively, pre-set) threshold distance from a location of the user terminal 300 of the buyer to which the payment ID is assigned. Accordingly, the payment processing server 100 according to an example embodiment may determine whether the payment ID included in the payment request is valid and whether the payment request is from the buyer related to the payment ID. As a result, the payment processing server 100 according to an example embodiment may prevent the payment ID from being used by another user, and prevent payment from being continuously performed by a user (other than a user who have just obtained the payment ID) using previously issued payment ID. The second determiner 142 may determine whether the payment request satisfying the first condition satisfies a second condition. Here, the second condition is a condition regarding the buyer related to the payment ID, and may include at least one of whether the buyer who received the payment ID has a payment method, whether there is a payment method registered by the buyer, whether a validity period of the payment method registered by the buyer has elapsed, and whether the payment method is usable. Here, whether the payment method is usable may be determined based on whether the use of the payment method is stopped due to a loss report, whether the user's credit or usage limit has been exceeded, or the like. Generally, validity of a payment method may be determined through a response from the external payment gateway server. The payment processing server 100 according to an example embodiment may determine the validity of the payment method in consideration of information about the pre-registered payment method, without having to communicate with the payment gateway server through the second determiner 142.

The evaluator 143 may evaluate that the payment request is valid when the first and second determiners 141 and 142 determine that the payment request satisfies the first and second conditions.

When the payment request is valid, the packet generator 144 may generate a transaction ID accessible to the buyer who is involved with the payment request, the seller, and payment information (e.g., a payment price and a payment product), and generate a packet including the transaction ID. One or more packets generated by the packet generator 144 may be stored in the message queue 120, for example, in a generated order. The message queue 120 is a storage space storing a packet corresponding to the payment to be processed. The message queue 120 may operate independently from the storage medium 140 or the database 110, and accordingly, may be included in a separate storage unit or in the same storage unit as the storage medium 140 or the database 110. The message queue 120 may be configured to be accessed only by a task generated to independently process a packet, so that the message queue 120 is not accessible by an OS, another process, or another thread. In some exceptional situations, the payment processing server 100 may stop accessing the message queue 120 through self-state monitoring. Such exceptional situations may include at least one of, for example, when the payment processing server 100 is turned off, when the payment processing server 100 is not connected to an internal or external module for a payment process, when an OS of the payment processing server 100 malfunctions, when the payment processing server 100 is attacked by a virus or a malignant code, and when a use rate of a CPU or memory is equal to or higher than a desired (or alternatively, pre-set) threshold value (e.g., 90%) by a processor or thread executed by the payment processing server 100. The message queue 120 may store only a desired (or alternatively, pre-set) threshold number of packets, and may transmit a signal that a packet can no longer be stored to the state monitor 146 when the desired (or alternatively, pre-set) threshold number is exceeded.

The task performer 145 may perform a function of controlling a task generated for the payment process. The task performer 145 may be set to operate independently from operations of other components included in the storage medium 140. The task performer 145 may perform operations of reading, deleting, or changing a packet stored in the message queue 120. Components other than the task performer 145 may not be able to read or delete the packet stored in the message queue 120. The task performer 145 may read or delete data stored in the message queue 120 by managing a decryption key of the data stored in the message queue 120. The task performer 145 may process packets stored in the message queue 120, for example, in a stored order. The task performer 145 may process a payment corresponding to a packet by analyzing the packet. The task performer may self-process the payment corresponding to the packet based on sales-related information and purchase-related information extracted from the packet. Here, processing of the payment may mean that a payment corresponding to the sales-related information is performed through a payment method of the buyer and sale money for the payment is paid to an account of the seller. The task performer 145 may process a first packet that is stored first from among one or more packets stored in the message queue 120, and may stand by until a process result of the first packet is received. Upon receiving TRUE as the process result of the first packet, the task performer 145 deletes the first packet from the message queue 120, and determines that the payment corresponding to the first packet has been processed. Then, the task performer 145 may process a next packet until packets stored in the message queue 120 are entirely deleted. Here, the task performer 145 may process a packet by using an independent memory or CPU, separately from another process or another thread performed by the processor 130. When FALSE is received as the process result of the first packet, the task performer 145 may re-transmit the first packet after a certain period of time, or determine that the payment corresponding to the first packet is not processed.

The task performer 145 may access the message queue 120 sporadically or periodically at a short time intervals (e.g., 1 second or 0.1 second) to check whether there is a packet stored in the message queue 120. When a packet is stored, the task performer 145 may process packets, for example, in a stored order. In some example embodiments, the task performer 145 may process packets stored in the message queue 120 in a stored order when an event or interrupt, which is generated when a packet is stored in the message queue 120, is received. The task performer 145 may selectively process the payment by exchanging data with the external payment gateway server.

The state monitor 146 may transmit a payment process state of the task performer 145 to the user terminals 200 of the seller and the user terminals 300 of the buyer. When the payment process state is TRUE, the state monitor 146 may transmit purchase data to the user terminal 300 of the buyer and transmit sales data to the user terminal 200 of the seller. The purchase data may be stored as a purchase history, and the sales data may be stored as a sales history through, for example, the payment application installed in the user terminals 200 and 300. The purchase data may be generated based on the payment information obtained through the transaction ID and may include ID information (e.g., a phone number and/or an address) of the seller. The sales data may be generated based on the payment information obtained through the transaction ID, but may not include ID information and personal information (e.g., a phone number, a name, and/or an address) of the buyer, unlike the purchase data.

When the payment process state is FALSE, the state monitor 146 may transmit a message indicating that the payment request has not been processed to the user terminal 200 of the seller. Here, the state monitor 146 may not transmit the message indicating that the payment request has not been processed to the user terminal 300 of the buyer.

According to an example embodiment, the state monitor 146 may extract the buyer from a transmission message received from the user terminal 200 of the seller by using a transaction ID included in the transmission message, and transmit the transmission message to the user terminal 300 of the buyer. The state monitor 146 may determine a recipient of the transmission message by using the transaction ID derived by analyzing the transmission message, and transmit the transmission message to a user terminal of the recipient. The transmission message may include completion of a sales activity and/or completion of a following action of the sales activity. For example, a seller selling food and a beverage may generate a transmission message about completion of preparing the food and beverage without a separate notification device, and transmit the transmission message to the user terminal 300 of the buyer. A seller operating an online shopping website may generate a transmission message based on a delivery state (e.g., release and delivery) of a product, and transmit the transmission message to the user terminal 300 of the buyer. According to an example embodiment, the seller may be able to transmit the transmission message to the buyer based on a sales history without having to check personal information (e.g., a phone number or ID) of the buyer. The buyer may receive information, as to a following action (e.g., completion of preparing the food and beverage) of a sales activity through the user terminal 300 carried by the buyer, even when the buyer is not at a sales place.

The state monitor 146 may transmit a message indicating that payment is not possible to the user terminal 200 of the seller, when the number of packets stored in the message queue 120 exceeds a threshold number. Here, the state monitor 146 may not transmit the message indicating that the payment is not possible to the user terminal 300 of the buyer.

The state monitor 146 may extract the purchase data of the buyer by using a transaction ID extracted from an inquiry message received from the user terminal 300 of the buyer, and transmit the inquiry message linked to sales data corresponding to the purchase data to the user terminal 200 of the seller. The state monitor 146 may extract the sales data of the seller by using the transaction ID included in the inquiry message received from the user terminal 200 of the seller, and transmit the inquiry message to the user terminal 200 of the seller. For example, the buyer may transmit an inquiry message of checking a completion time of making the food or beverage or checking a delivery state of a product purchased through an online shopping website from a purchase history, or an inquiry message related to a size or a color of a product to the seller without having to check personal information or ID information (e.g., a phone number or ID) of the seller. Accordingly, the payment processing server 100 according to an example embodiment enables the buyer and the seller to transmit a message to the seller and the buyer, respectively, even when they do not know each other's personal information (e.g., a phone number and ID). The payment processing server 100 according to an example embodiment may prevent personal information of the buyer from being exposed through product purchase. The payment processing server 100 according to an example embodiment may prevent personal information of the seller from being exposed through product sales.

The chat room manager 147 may open a chat room in response to a chat room open request by using purchase data of the user terminal 300 of the buyer or sales data of the user terminal 200 of the seller. When the chat room open request is received from the user terminal 300 of the buyer, the chat room manager 147 may search for seller information by using transaction ID obtained by analyzing the chat room open request, and determine a found seller as a participant of a chat room. Here, information related to the seller who is the participant may be provided to the user terminal 300 of the buyer.

When the chat room open request is received from the user terminal 200 of the seller, the chat room manager 147 may search for a buyer by using a transaction ID obtained by analyzing the chat room open request, and determine a found buyer as a participant of a chat room. Here, information related to the buyer who is the participant may not be provided to the user terminal 200 of the seller. Messages exchanged in the chat room may be provided to the buyer and the seller, but personal information of the buyer and/or the seller may not be provided.

The payment processing server 100 according to an example embodiment may have a capability of pre-registering a payment method or seller information through the payment application installed in the user terminals 200 and 300. Here, a registration process may vary based on a type of the payment method. A payment method of the buyer may include a usable credit card and account transferable account information. Further, a payment method of a user other than the buyer may be registered. In this case, the payment processing server 100 according to an example embodiment may transmit payment information according to the payment method to a user terminal of a user of the payment method, and transmit a transmission message from the seller to a user terminal of the buyer.

The payment processing server 100 according to an example embodiment may generate a payment method according to an advance payment amount paid by a first user, and transmit the payment method to a second user. The second user may perform a purchase activity by using the payment method generated by the first user. For example, the first user may pay a certain amount of money by using a payment method owned by the first user, and present the paid amount of money to the second user. In this case, the payment processing server 100 may register the second user as owning the payment method of the paid amount of money. Here, the second user may own the payment method of the paid amount of money only when the second user approves or accepts the paid amount of money by the first user. The second user may own the payment method paid or registered by another user without determining its validity.

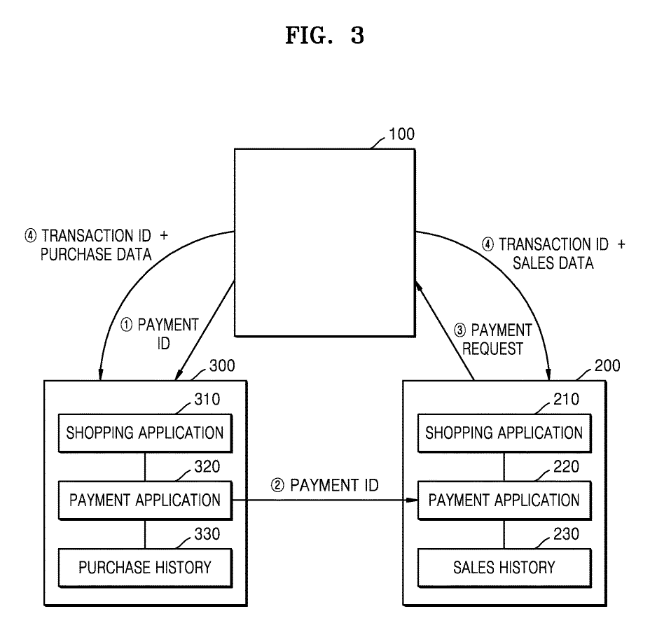

FIG. 3 is a diagram for describing a data exchange between the payment processing server 100, the user terminal 300 of the buyer, and the user terminal 200 of the seller.

The user terminal 200 of the seller may install a payment application 220 distributed by the payment processing server 100, and store a sales history 230 sold by the payment application 220. Further, the user terminal 200 of the seller may additionally install a shopping application 210 for selling a sales item by registering information about a store of the seller and sales items.

The user terminal 300 of the buyer may store a shopping application 310 and a payment application 320 distributed by the payment processing server 100. Further, the user terminal 300 of the buyer may store a purchase history 330 that is information related to purchases of the buyer through the payment application 320.

The payment processing server 100 may issue a payment ID according to a request of the buyer, and transmit the payment ID to the user terminal 300 of the buyer. For example, the user terminal 300 of the buyer receives the payment ID through the payment application 320. The payment ID may be transmitted to the payment application 220 of the seller through the payment application 320 of the buyer. For example, the payment ID may be recognized through an image sensor included in the user terminal 200 of the seller, or may be transmitted via a short-range communication. The user terminal 200 of the seller may transmit a payment request to the payment processing server 100. In response to the payment request, the payment processing server 100 may generate a transaction ID corresponding to the payment request in consideration of sales information and the payment ID included in the payment request, and perform a payment process using the transaction ID. Further, the payment processing server 100 may transmit sales data including the transaction ID to the user terminal 200 of the seller, and transmit purchase data including the transaction ID to the user terminal 300 of the buyer.

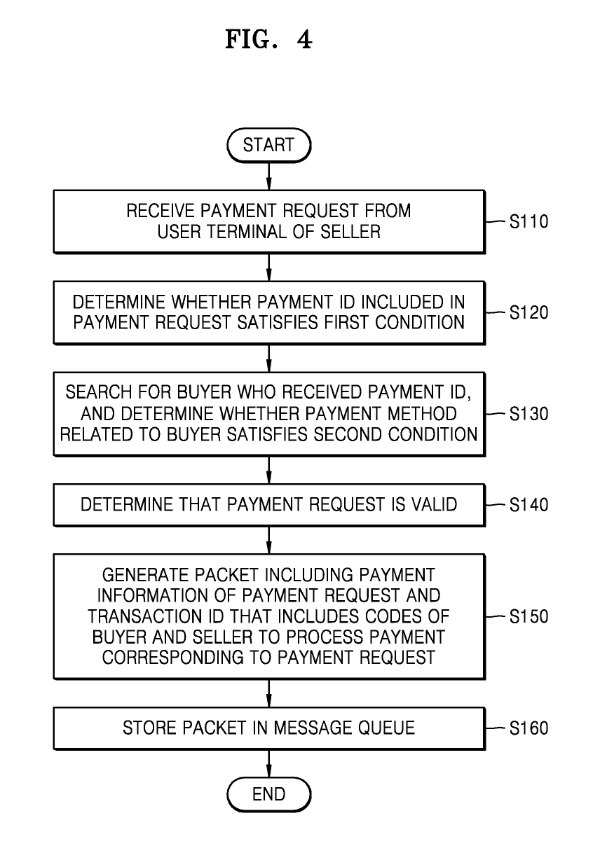

FIGS. 4 through 7 are flowcharts of a payment processing method according to an example embodiment.

Referring to FIG. 4, a payment processing method according to an example embodiment may include receiving of a payment request (operation S110), determining of payment ID (operation S120), determining of a payment method (operation S130), evaluating of validity of the payment request (operation S140), generating of a packet (operation S150), and storing of the packet (operation S160).

In operation S110, the payment processing server 100 may receive a payment request from the user terminal 200 of the seller. For example, the payment request may be a request generated by a payment application installed in the user terminal 200 of the seller, and may include registration information pre-registered by the user terminal 200 of the seller and input information newly input by the user terminal 200 of the seller. For example, the payment request may include a payment ID obtained from the user terminal 300 of the buyer. The payment ID may be a single-use (e.g., one-time) ID or temporarily valid ID provided to the user terminal 300 of the buyer. The payment ID may identify the user terminal 300 or the buyer while not being relevant to the user terminal 300 of the buyer. For example, the user terminal 300 of the buyer and the user terminal 200 of the seller may be generally different, but may be the same under certain circumstances. For example, a terminal owned by a person who is both a buyer and a seller may be both a buyer terminal and a seller terminal.

In operation S120, the payment processing server 100 may primarily determine whether the payment ID included in the payment request satisfies a first condition. The payment processing server 100 may primarily determine whether the payment ID included in the payment request is valid. The first condition may be a condition regarding the payment ID, and may include at least one of whether a number, a sign, an English character, or the like included in the payment ID satisfies a regulation of payment ID, whether a validity period of the payment ID is expired, and whether a location of the user terminal 200 of the seller is within a desired (or alternatively, pre-set) threshold distance from a location of the user terminal 300 of the buyer to which the payment ID is assigned. Accordingly, the payment processing server 100 may determine whether the payment ID included in the payment request from the user terminal 200 of the seller is valid through the primary determination.

In operation S130, the payment processing server 100 may search for the buyer who received the payment ID, and secondarily determine whether a payment method related to the buyer satisfies a second condition. The second condition may be a condition regarding the buyer related to the payment ID, and may include at least one of whether the buyer who received the payment ID has a payment method, whether there is a payment method registered by the buyer, whether a validity period of the payment method registered by the buyer has elapsed, and whether the payment method is usable. Whether the payment method is usable may be determined based on whether the use of the payment method is stopped due to a loss report, whether the user's credit or usage limit is exceeded, or the like. The payment processing server 100 may determine whether payment may be processed by the payment method of the buyer who received the payment ID included in the payment request, through the secondary determination.

In operation S140, when the first and second conditions are satisfied, the payment processing server 100 may determine that the payment request is valid. The payment processing server 100 may immediately process the payment with respect to the valid payment request.

In operation S150, the payment processing server 100 may generate a packet including payment information of the payment request and a transaction ID that includes codes of the buyer and the seller, so as to process the payment corresponding to the payment request. For example, the payment information of the payment request may include information about a payment price and a payment product. The codes of the buyer may be codes assigned according to an ID of the buyer. The codes may not directly correspond to, but indirectly correspond to a name, payment method, and other personal information of the buyer. The codes of the seller may be codes assigned according to ID of the seller, and may not directly correspond to personal information (e.g., a name and a business registration number) of the seller. The transaction ID may be generated to include the codes of the seller and the codes of the buyer while corresponding to one payment request. Each payment request may be managed by unique transaction ID.

In operation S160, the payment processing server 100 may store the packet in a message queue. The payment processing server 100 may store the packet in the message queue (e.g., a storage region provided independently from a database). The storage region storing the message queue may be set by a manager, and may be a non-volatile storage medium. In some example embodiments, the message queue may be configured to be inaccessible by an OS or a computer program to maintain independence and safety.

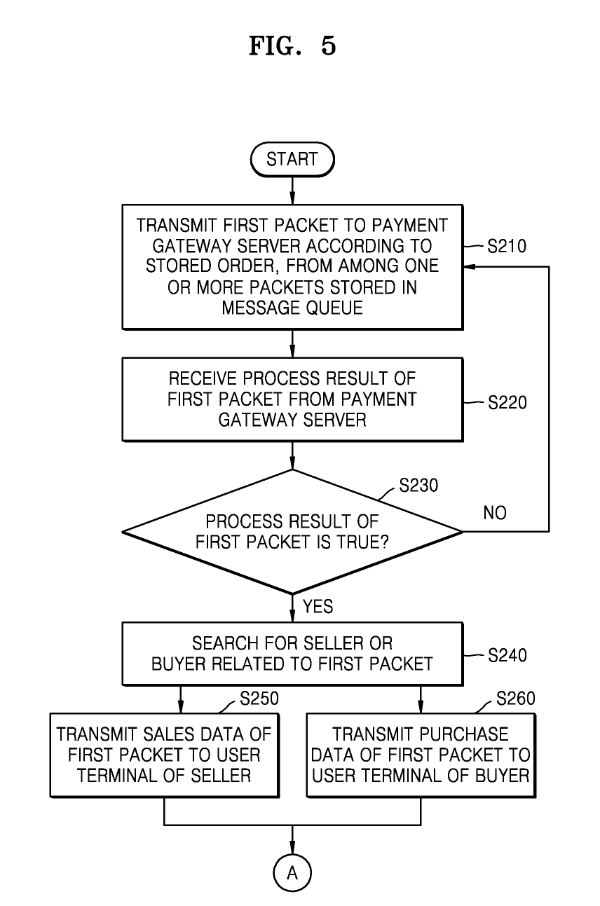

Referring to FIG. 5, the payment processing method according to the example embodiment may further include processing a first packet stored in the message queue (operation S210), receiving a process result of the first packet (operation S220), determining whether the process result of the first packet is TRUE (operation S230), searching for a seller and a buyer related to the first packet (operation S240), transmitting sales data of the first packet to the user terminal 200 of the seller (operation S250), and transmitting purchase data of the first packet to the user terminal 300 of the buyer (operation S260).

In operation S210, the payment processing server 100 may process one or more packets stored in the message queue for payment according to, for example, a stored order. The payment processing server 100 may generate a task performer for processing the packets stored in the message queue, and perform a function of managing the message queue through the task performer. The task performer may access the message queue sporadically or periodically at short time intervals (e.g., 1 second or 0.1 second) to determine whether a packet is stored in the message queue, and process packets in, for example, a stored order when there is a stored packet. In some example embodiment, the task performer may process packets stored in the message queue in a stored order when an event or interrupt, which is generated when a packet is stored in the message queue, is received. The payment processing server 100 may stop accessing the message queue under certain exceptional situations through self-state monitoring. Such exceptional situations may include at least one of, for example, when the payment processing server 100 is turned off, when the payment processing server 100 is not connected to an internal or external module for a payment process, when an OS of the payment processing server 100 malfunctions, when the payment processing server 100 is attacked by virus or a malignant code, and when a use rate of a CPU or memory is equal to or higher than a desired (or alternatively, pre-set) threshold value (e.g., 90%) by a processor or thread executed by the payment processing server 100.

In operation S220, the payment processing server 100 may receive the process result of the first packet.

In operation S230, the payment processing server 100 may determine whether the process result of the first packet is TRUE.

In operation S240, when the process result of the first packet is TRUE, the payment processing server 100 may remove or delete the first packet from the message queue, and search for the seller or the buyer related to the first packet. The payment processing server 100 may search for the seller or the buyer by using transaction ID included in the first packet. The payment processing server 100 may extract a portion corresponding to the buyer and a portion corresponding to the seller from the transaction ID included in the first packet, and find the buyer from the portion corresponding to the buyer and the seller from the portion corresponding to the seller.

In operation S250, the payment processing server 100 may transmit sales data of the first packet to the user terminal 200 of the seller. The payment processing server 100 may search the database 110 for payment information by using the transaction ID obtained by analyzing the first packet. The payment processing server 100 may generate the sales data in which information related to the buyer is deleted from the payment information. Accordingly, the payment processing server 100 according to this example embodiment may provide the sales data for accessing the buyer without exposing personal information of the buyer to the user terminal 200 of the seller.

In operation S260, the payment processing server 100 may extract purchase data generated by the buyer from the first packet, and transmit the extracted purchase data to the user terminal 300 of the buyer. The payment processing server 100 may search the database 110 for the payment information by using the transaction ID. The payment processing server 100 may generate the purchase data including, for example, payment information, a payment price, a payment date/time, a store, and/or a phone number of the seller. The user terminal 300 of the buyer may manage one or more pieces of purchase data received from the payment processing server 100 as a whole regardless of a type of a credit card (e.g., payment method). The purchase data may be generated based on the payment information obtained through the transaction ID, and may include ID information (e.g., a phone number and an address) of the seller.

Accordingly, the payment processing server 100 according to an example embodiment may manage a purchase history performed by the user terminal 300 of the buyer regardless of a payment method.

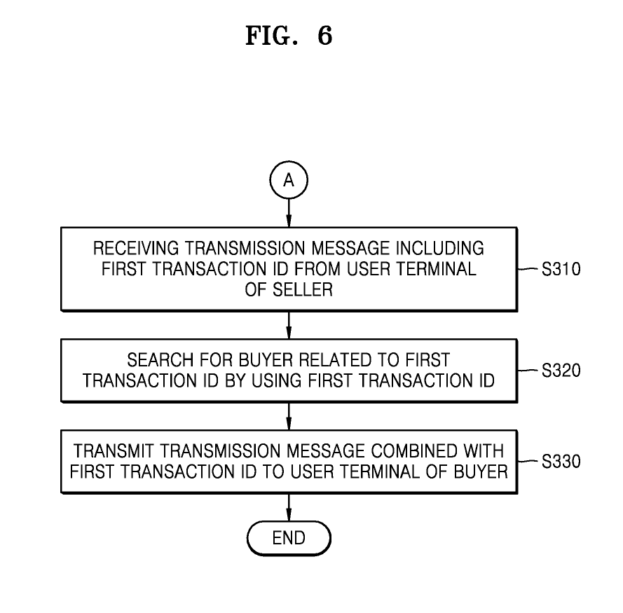

Referring to FIG. 6, the payment processing method according to the example embodiment may further include receiving a transmission message including first transaction ID from the user terminal 200 of the seller (operation S310), searching for a buyer related to the first transaction ID (operation S320), and transmitting the transmission message to the user terminal 300 of the buyer (operation S330).

In operation S310, the payment processing server 100 may receive the transmission message including the first transaction ID with respect to certain sales data from the user terminal 200 of the seller. The sales data may be generated based on the payment information, while not including ID information and personal information (e.g., a phone number, a name, and an address) of the buyer, unlike purchase data.

In operation S320, the payment processing server 100 may search for the buyer related to the first transaction ID by using the first transaction ID. In operation S330, the payment processing server 100 may transmit the transmission message combined with the first transaction ID to the user terminal 300 of the buyer. The user terminal 300 of the buyer may search for a purchase history related to the transmission message by using the first transaction ID, and store the transmission message in relation to the purchase history. The user terminal 300 of the buyer may display the reception of the transmission message in relation to the purchase history.

The transmission message may include completion of a sales activity and/or completion of a following action of the sales activity. For example, a seller selling food and beverage may generate a transmission message about completion of preparing the food and beverage without a separate notification device, and transmit the transmission message to the user terminal 300 of the buyer. A seller operating an online shopping website may generate a transmission message based on a delivery state (e.g., release and a delivery) of a product, and transmit the transmission message to the user terminal 300 of the buyer. According to an example embodiment, the seller may be able to transmit the transmission message to the buyer based on a sales history without having to check personal information (e.g., a phone number or ID) of the buyer. The buyer may receive information at to a following action (e.g., completion of preparing the food and beverage) of a sales activity through the user terminal 300 carried by the buyer, even when the buyer is not at a sales place.

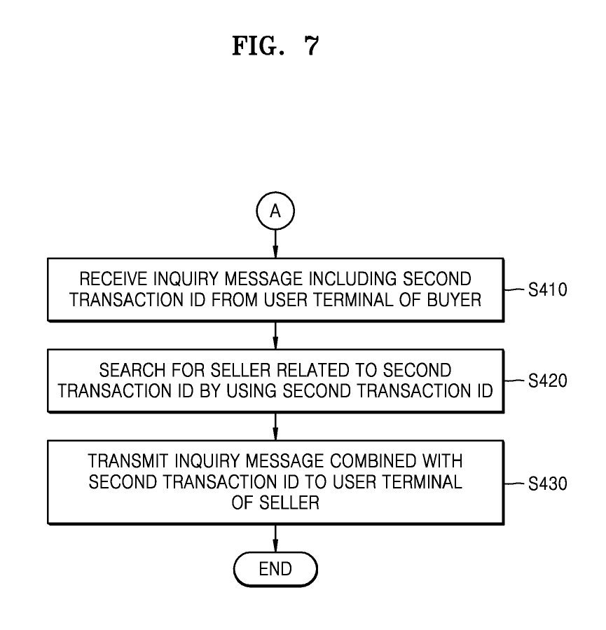

Referring to FIG. 7, the payment processing method according to the example embodiment may further include receiving an inquiry message including second transaction ID from the user terminal 300 of the buyer (operation S410), searching for a seller related to the second transaction ID by using the second transaction ID (operation S420), and transmitting the inquiry message combined with the second transaction ID to the user terminal 200 of the seller (operation S430).

In operation S430, the payment processing server 100 may transmit the inquiry message to the user terminal 200 of the seller and open a chat room for a communication between the buyer and the seller.

For example, the buyer may transmit an inquiry message of checking a completion time of preparing food or beverage or checking a delivery state of a product purchased through an online shopping website from a purchase history, or an inquiry message related to a size or a color of a product to the seller without having to check personal information or ID information (e.g., a phone number or ID) of the seller. Accordingly, the payment processing server 100 according to this example embodiment enables the buyer and the seller to transmit a message to the seller and the buyer, respectively, even when they do not know each other's personal information (e.g., a phone number and ID). The payment processing server 100 according to this example embodiment may prevent personal information of the buyer from being exposed through product purchase.

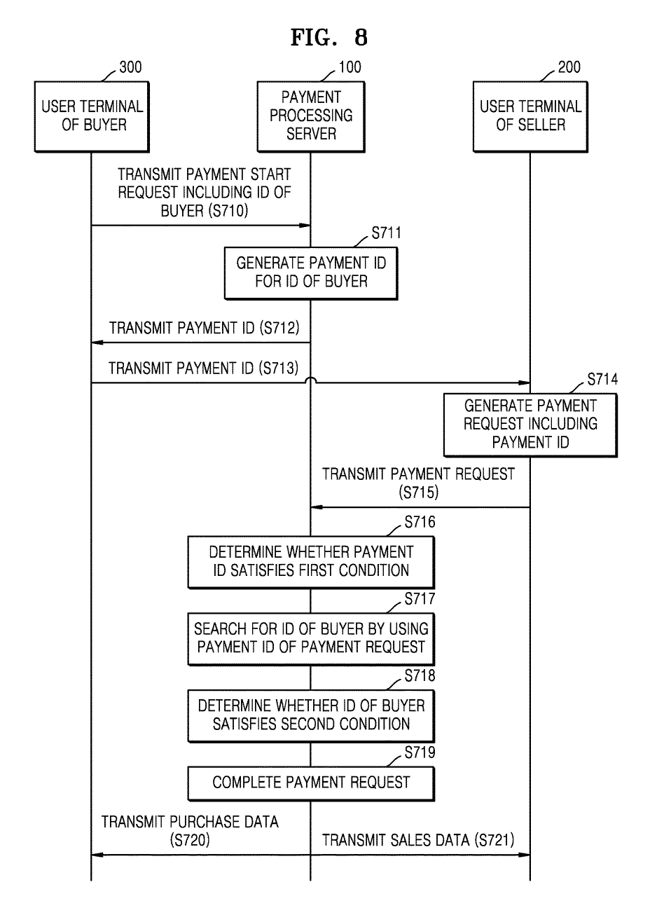

FIGS. 8 through 10 are diagrams for describing data exchanges between the payment processing server 100, the user terminal 200 of the seller, and the user terminal 300 of the buyer.

Referring to FIG. 8, the user terminal 300 of the buyer may transmit a payment start request including ID of the buyer to the payment processing server 100, in operation S710. The payment processing server 100 may generate payment ID for the ID of the buyer, in operation S711. The payment processing server 100 may transmit the payment ID to the user terminal 300 of the buyer, in operation S712. The user terminal 300 of the buyer may transmit the payment ID to the user terminal 200 of the seller, in operation S713. The user terminal 200 of the seller may generate a payment request including the payment ID in operation 5714. The user terminal 200 of the seller may transmit the payment request to the payment processing server 100 in operation S715. The payment processing server 100 may determine whether the payment ID satisfies the first condition, in operation S716. The payment processing server 100 may search for the ID of the buyer by using the payment ID of the payment request, in operation S717. The payment processing server 100 may determine whether the ID of the buyer satisfies the second condition, in operation S718. The payment processing server 100 may evaluate that the payment request is valid. When a process result corresponding to the payment request is TRUE, the payment processing server 100 completes the payment request in operation S719. When the payment request is completed, the payment processing server 100 may transmit purchase data to the user terminal 300 of the buyer in operation S720, and transmit sales data to the user terminal 200 of the seller in operation 5721.

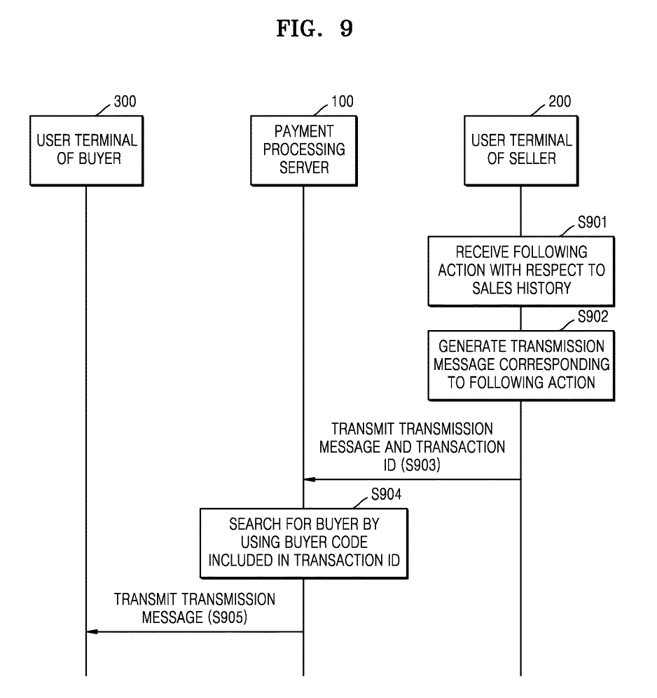

Referring to FIG. 9, the user terminal 200 of the seller may receive a following action with respect to a stored sales history in operation S901, and generate a transmission message corresponding to the following action in operation S902. The user terminal 200 of the seller may transmit the transmission message and transaction ID corresponding to the sales history to the payment processing server in operation S903. The payment processing server 100 may search for the buyer by using a buyer code found, obtained, or extracted by using the transaction ID in operation S904, and transmit the transmission message to the user terminal 300 of the buyer in operation S905. For example, a chat room for a communication between the user terminals 200 and 300 may be generated by using the buyer code, and the transmission message may be provided through the chat room.

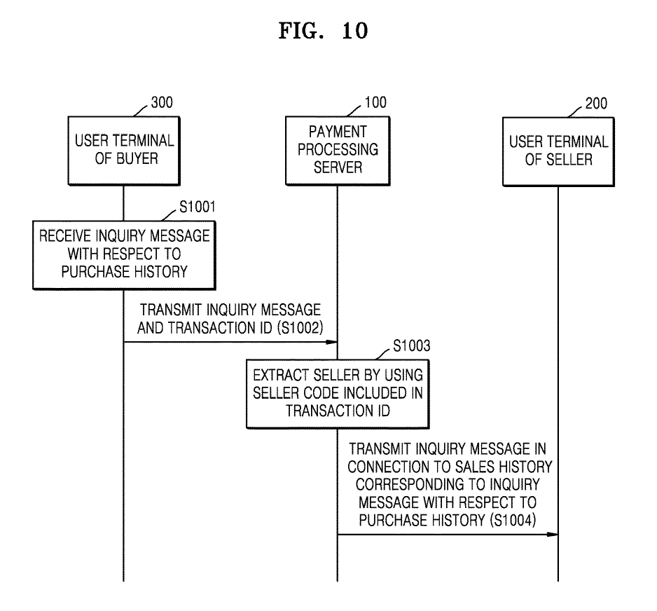

Referring to FIG. 10, the user terminal 300 of the buyer may receive an inquiry message with respect to a stored purchase history, in operation S1001. The user terminal 300 of the buyer may transmit the inquiry message and the transaction ID of the purchase history to the payment processing server 100 in operation S1002. The payment processing server 100 may extract the seller by using a seller code included in the transaction ID, in operation S1003. The payment processing server 100 may transmit the inquiry message in connection to a sales history corresponding to the inquiry message with respect to the purchase history, in operation S1004. For example, the payment processing server 100 may generate a chat room for a communication between the seller and the buyer by using the seller code, and provide the inquiry message through the chat room.

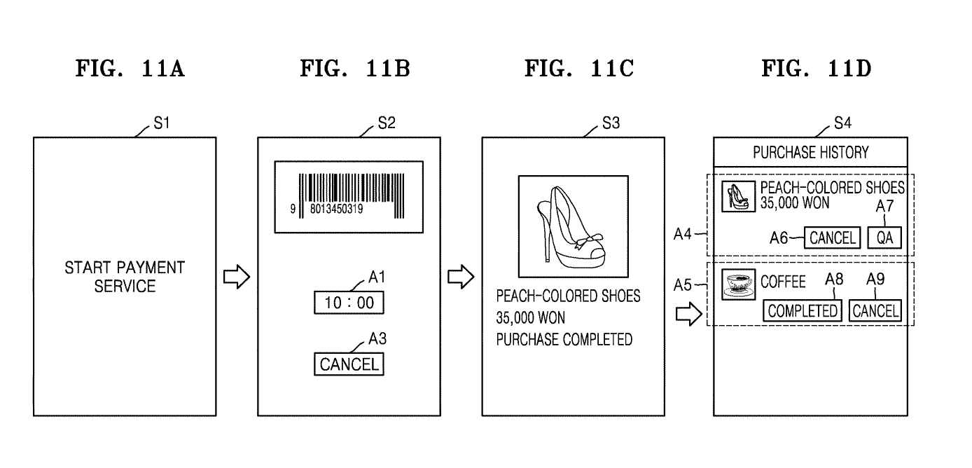

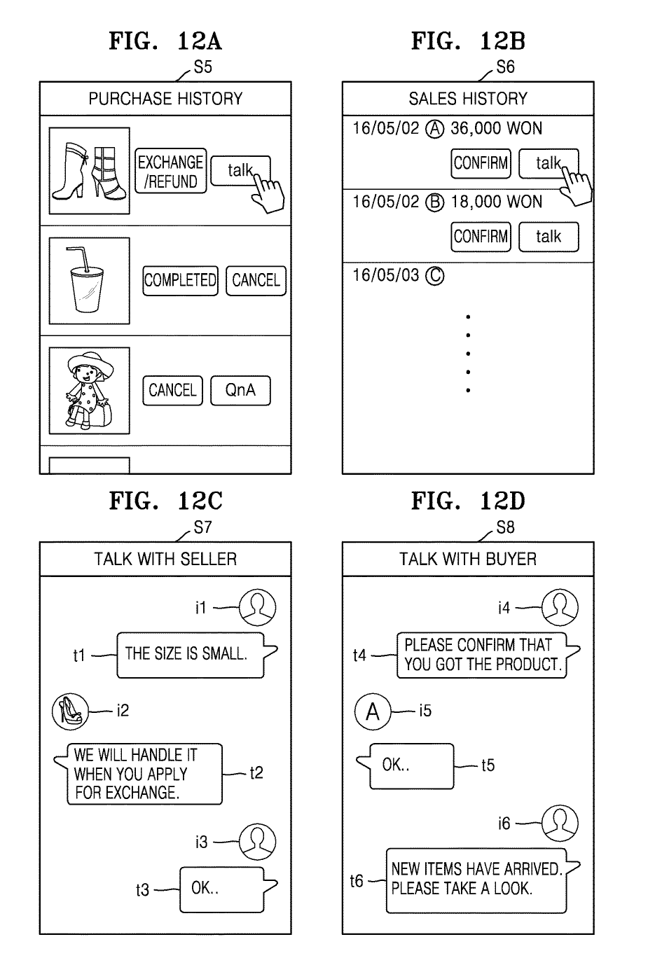

FIGS. 11A through 12D are user interfaces provided by the payment processing server 100. The user terminal 300 of the buyer may provide a first user interface S1 as shown in FIG. 11A by driving of a payment application. After the first user interface 31, the user terminal 300 of the buyer may provide a second user interface S2 including an image code (e.g., a barcode or a quick response (QR) code) corresponding to payment ID received from the payment processing server 100. The second user interface S2 may include a time display region A1 displaying a remaining valid time of the payment ID, and a cancel button region A3 for returning to a previous user interface or to a home screen when the buyer is no longer interested in making a payment. When the second user interface S2 is recognized through the user terminal 20 of the seller, the user terminal 300 of the buyer may provide a third user interface S3 providing purchase data indicating that purchase is completed. The third user interface S3 may include information related to a purchased product.

The purchase data may be added to a fourth user interface S4 for providing a purchase history. The fourth user interface S4 may include a list of first purchase data A4 and second purchase data A5, wherein the first purchase data A4 about a product purchased through an online shopping website may include a button A6 for canceling purchase and a button A7 for sending an inquiry to a seller, and the second purchase data A5 about a product purchased through an offline food and beverage store may include a completion notification button A8 and a button A9 for canceling purchase. The buyer may determine whether to complete or not his/her order for the food or beverage through the second purchase data A5.

As shown in FIGS. 12A through 12D, the payment processing server 100 may open a chat room for exchanging messages between a buyer terminal and a seller terminal according to a chat room open request received from the buyer terminal or the seller terminal. A buyer or a seller connected through a payment statement may have an interface window for talking to a seller of a purchase history or a buyer of a sales history by using the purchase history or the sales history stored in each terminal. The buyer and the seller may communicate with each other by using the purchase history or the sales history provided by the payment processing server 100, even if the buyer and the seller do not have each other's personal information (e.g., a phone number or an email address) for contacting each other.

As shown in FIG. 12A, the buyer terminal may provide a screen S5 for providing a purchase history. Purchase data included in the purchase history may not only include information about a purchased product, but also a button for applying for exchange/refund, a button for opening a chat room, a button for confirming purchase, a button for canceling purchase, and a button for transmitting an inquiry message. When a selection input is received from the buyer with respect to the button for opening a chat room or the button for transmitting an inquiry message, the buyer terminal may transmit a request corresponding to the selection input to the payment processing server 100. The payment processing server 100 may open a chat room S7 for the buyer and the seller in response to the request. For example, the payment processing server 100 may search for and extract the seller by using transaction ID obtained by analyzing the purchase data. In some example embodiments, profiles of participants of the chat room may be generated virtually such that personal information of the participants is not exposed. Referring to FIG. 12C, the payment processing server 100 may set an image of a product sold by the seller from among the participants as a profile i2 of the seller. A message t2 received from the seller may be provided in connection to the profile i2. Profiles i1 and i3 of the buyer include a profile photograph set by the buyer, and messages t1 and t3 input by the buyer may be provided in connection to the profiles i1 and i3.

As shown in FIG. 12B, the seller terminal may provide a screen 36 for providing a sales history. Sales data included in the sales history may include a sold date, a selling price, and virtual ID information corresponding to the buyer. The sales history may include a button for confirming sales, and a button for transmitting a transmission message or opening a chat room. When a selection input is received with respect to the button for opening a chat room or transmitting a transmission message, a screen S8 (as shown in FIG. 12D) for providing a chat room with the buyer may be provided by the seller terminal. For example, the screen S8 may provide a virtual profile i5 of the buyer. The virtual profile i5 of the buyer may only include virtual ID and include a random image. A message t5 input by the buyer may be provided in connection to the virtual profile i5 of the buyer. Profiles i4 and i6 of the seller may be provided only to the seller, and may be set by the seller. Messages t4 and t6 may be provided in connection to the profiles i4 and i6 of the seller.

According to an example embodiment, payment may be performed without being directly connected to a buyer by receiving the payment request from a seller terminal using a payment request in which payment ID issued to the buyer and sale information generated by a seller are combined. According to an example embodiment, communication may be initiated or performed based on transaction data without having to exchange or expose personal ID information between the buyer and the seller.

The foregoing description has been provided for purposes of illustration and description. It is not intended to be exhaustive or to limit the disclosure. Individual elements or features of a particular example embodiment are generally not limited to that particular example embodiment, but, where applicable, are interchangeable and can be used in a selected example embodiment, even if not specifically shown or described. The same may also be modified in various ways. Such modifications are not to be regarded as a departure from the disclosure, and all such modifications are intended to be included within the scope of the disclosure.

What is claimed is:

1. A payment processing method performed by a payment processing server, the payment processing server including a communication interface and a processor, the payment processing method comprising:
receiving, by the communication interface, a payment request comprising a payment identification (ID) from a first user terminal of a first user;
primarily determining, by the processor, whether the payment ID satisfies a certain regulation, and whether a validity period of the payment ID has elapsed;
searching for a second user who received the payment ID, and secondarily determining whether a payment method related to the second user exists and whether a validity period of the payment method has elapsed in response to results of the primary determination that the payment ID satisfies the certain regulation and the validity period of the payment ID has not elapsed;
evaluating that the payment request is valid in response to results of the secondary determination that the payment method exists and the validity period of the payment method has not elapsed;
generating a packet including a transaction ID corresponding to the payment request, and storing the packet in a message queue in response to the payment request being valid; and
processing the payment request to make a payment corresponding to the payment request.

2. The payment processing method of claim 1, wherein the transaction ID comprises a portion corresponding to a buyer code, a portion corresponding to a seller code, and a portion corresponding to payment information and
the portion corresponding to a buyer code don't comprise directly buyer's identification code and comprises codes that be substituted by the buyer code.

3. The payment processing method of claim 2, further comprising: transmitting sales data generated based on a store, a sales item, and a selling price, which are included in results of the processing the payment request, to a second user terminal of the second user;
receiving a transmission message with respect to the sales data from the second user terminal;
determining a recipient of the transmission message by using a transaction ID derived by analyzing the transmission message; and
transmitting the transmission message to a user terminal of the recipient.

4. The payment processing method of claim 3, wherein the transmission message comprises at least one of a menu completion notification, a product delivery notification, an out-of-stock notification, and a delivery schedule notification.

5. The payment processing method of claim 1, further comprising:
transmitting purchase data generated based on a store, a sales item, and a selling price, which are derived by analyzing results of the processing the payment request, to the first user terminal;
receiving an inquiry message with respect to the purchase data from the first user terminal;
extracting a seller of the purchase data by using a transaction ID extracted from the received inquiry message;
modifying the inquiry message to be linked to sales data corresponding to the purchase data; and
transmitting the inquiry message to a user terminal of the seller.

6. The payment processing method of claim 1, wherein the payment ID is generated in response to a payment start request from a second user terminal, and is transmitted only to the second user terminal.

7. The payment processing method of claim 3, further comprising:
receiving a chat room open request using sales data of the second user terminal;
extracting a participant of a chat room by using a transaction ID obtained by analyzing the chat room open request; and
opening the chat room including the participant.

8. The payment processing method of claim 7, further comprising:
enabling the second user to exchange a message with the participant using the transaction ID without exposing respective personal information.

9. The payment processing method of claim 5, further comprising:
receiving a chat room open request using purchase data of the first user terminal;
extracting a participant of a chat room by using a transaction ID obtained by analyzing the chat room open request; and
opening the chat room including the participant.

10. The payment processing method of claim 9, further comprising:
enabling the first user to exchange a message with the participant using the transaction ID without exposing respective personal information.

11. A payment processing server comprising:
a communication interface configured to receive a payment request, the payment request including a payment identification (ID) from a first user terminal of a first user; and
the processor configured to,
primarily determine whether the payment ID satisfies a certain regulation, and whether a validity period of the payment ID has elapsed,
search for a second user who received the payment ID, and secondarily determine whether a payment method related to the second user exists and whether a validity period of the payment method has elapsed in response to results of the primary determination that the payment ID satisfies the certain regulation and the validity period of the payment ID has not elapsed,
evaluate that the payment request is valid in response to results of the secondary determination that the payment method exists and the validity period of the payment method has not elapsed, and
generate a packet including a transaction ID corresponding to the payment request in response to the payment request being valid,
store the packet in a message queue, and
process the payment request to make a payment corresponding to the payment request.

12. The payment processing server of claim 11, wherein the transaction ID comprises a portion corresponding to a buyer code, a portion corresponding to a seller code, and a portion corresponding to payment information and
the portion corresponding to a buyer code don't comprise directly buyer's identification code and comprises codes that be substituted by the buyer code.

13. The payment processing server of claim 11, wherein the processor is further configured to,
transmit sales data generated based on a store, a sales item, and a selling price, which are included in results of the processing the payment request to a second user terminal of the second user,
receive a transmission message with respect to the sales data from the second user terminal,
determine a recipient of the transmission message by using a transaction ID derived by analyzing the transmission message, and
transmit the transmission message to a user terminal of the recipient.

14. The payment processing server of claim 13, wherein the transmission message comprises at least one of a menu completion notification, a product delivery notification, an out-of-stock notification, and a delivery schedule notification.

15. The payment processing server of claim 11, wherein the processor is further configured to,
transmit purchase data generated based on a store, a sales item, and a selling price, which are derived by analyzing results of the processing the payment request to the first user terminal,
receive an inquiry message with respect to the purchase data from the first user terminal,
extract a seller of the purchase data by using a transaction ID extracted from the received inquiry message,
modify the inquiry message to be linked to sales data corresponding to the purchase data, and
transmit the inquiry message to a user terminal of the seller.

16. The payment processing server of claim 13, wherein the processor is further configured to,
receive a chat room open request using sales data of the second user terminal,
extract a participant of a chat room by using a transaction ID obtained by analyzing the chat room open request, and
open the chat room including the participant.

17. The payment processing server of claim 16, wherein the processor is further configured to enable the second user who has opened the chat room to exchange messages with the participant without exposing respective personal information.

18. The payment processing server of claim 15, wherein the processor is further configured to,
receive a chat room open request using purchase data of the first user terminal,
extract a participant of a chat room by using a transaction ID obtained by analyzing the chat room open request, and
open the chat room including the participant.

19. The payment processing server of claim 18, wherein the processor is further configured to enable the first user who has opened the chat room to exchange messages with the participant without exposing respective personal information.

20. A non-transitory computer-readable recording medium storing a computer program, which when executed by a computer, configures the computer to execute the payment processing method of claim 1.
